(19) United States
(12) Patent Application Publication
(10) Pub. No.: US 2003/0031808 A1
(43) Pub. Date: Feb. 13, 2003

(54) Floral wrap

(76) Inventor: Carolyn Rasky, Westwood, MA (US)

Correspondence Address: Duane C. Blake, 67 Sterling Road, Westwood, MA, 02090, US

(21) Appl. No.: 10/210,453

(22) Filed: Aug. 1, 2002

Related U.S. Application Data
(60) Provisional application No. 60/309,445, filed on Aug. 2, 2001.

(51) Int. Cl. G09F 17/00

(52) U.S. Cl. 428/7; 428/10

(57) ABSTRACT

The present invention is directed to permanent yet changeable, malleable bodies for creating hanging or free-lying decorative floral arrangements. More specifically, the invention relates to the creation of floral arrangements as an integral part of simple, easy-to-use floral forms, which may be shaped and reshaped in any size and utilized to create tablescape, doorscape and candlescape designs.

### PRIORITY

The present application claims priority to U.S. provisional patent application No. 60/309,445, filed on Aug. 2, 2001.

### FIELD OF THE INVENTION

The present invention is directed to permanent yet changeable, malleable bodies for creating hanging or free-lying decorative floral arrangements. More specifically, the invention relates to the creation of floral arrangements as an integral part of simple, easy-to-use floral forms, which may be shaped and reshaped in any size and utilized to create tablescape, doorscape and candlescape designs.

### DRAWINGS

These and other features, aspects, and advantages of the present invention will become better understood with reference to the following description, and accompanying drawings where:

FIG. 1 is a side view of the flexible tubular mesh weave body according to the present invention, including an example of male and female clamps situated at the terminal ends of the body;

FIG. 2 is a side view of the invention exhibiting a semi-circular shape;

FIG. 3 is a side view of the invention exhibiting an s-curve shapes;

FIG. 4 is a side view of the end caps of the present invention;

FIG. 5a is a side view of the invention illustrating an example of a clip art specimen;

FIG. 5b is a side view of the invention illustrating an example of a bow clip specimen.

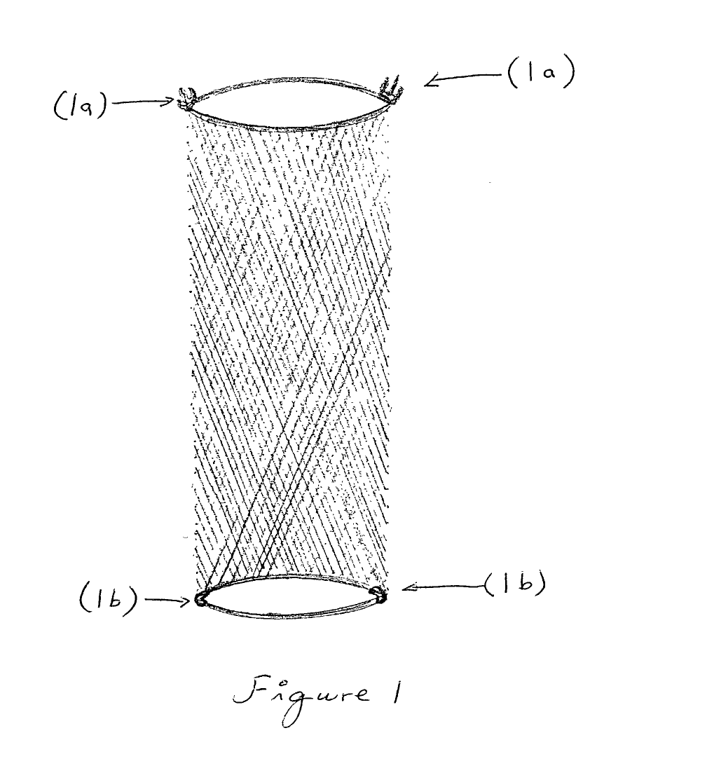

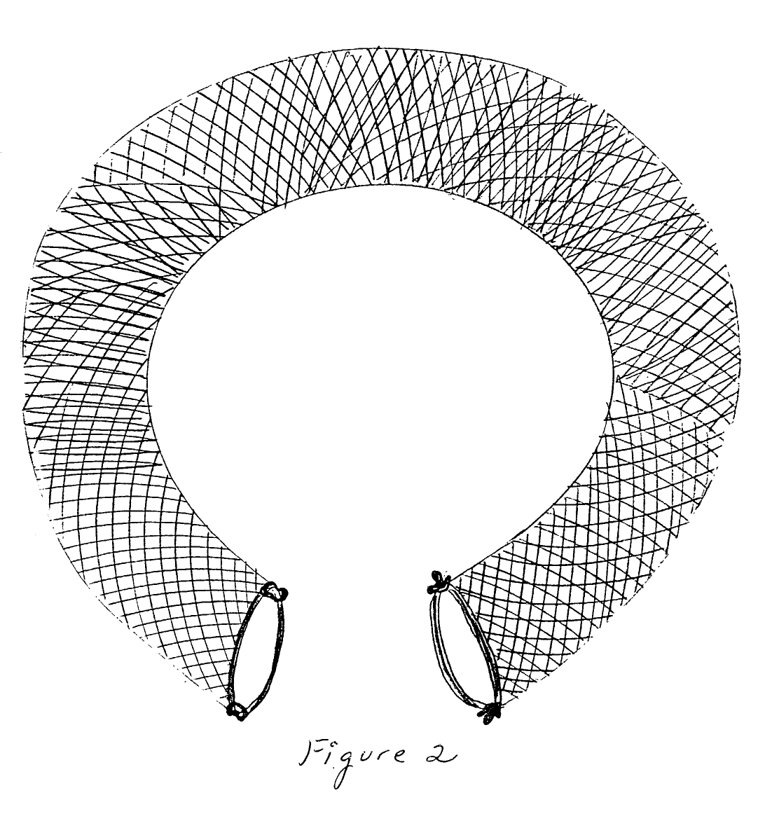

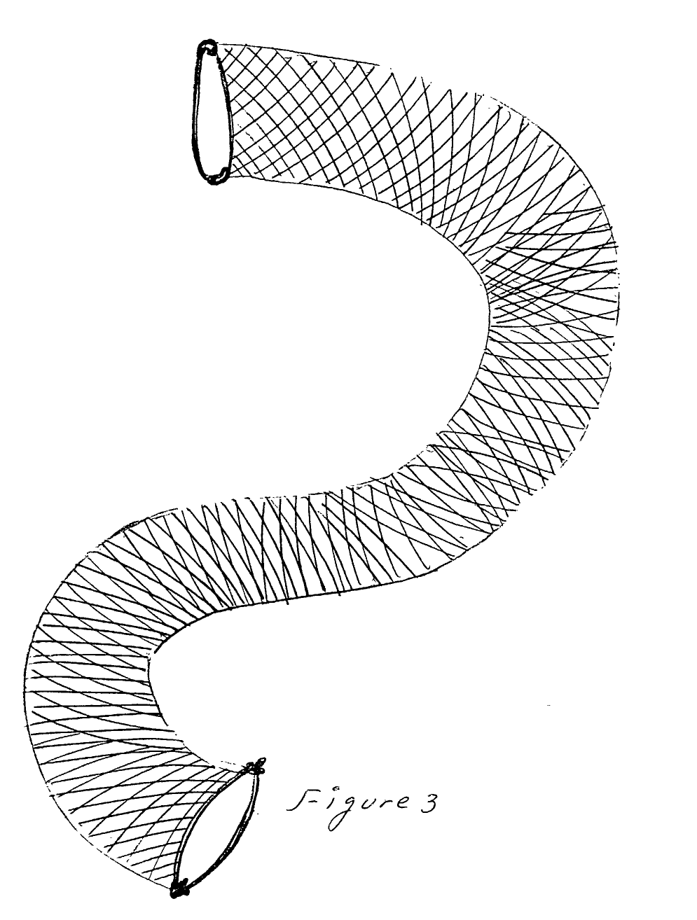

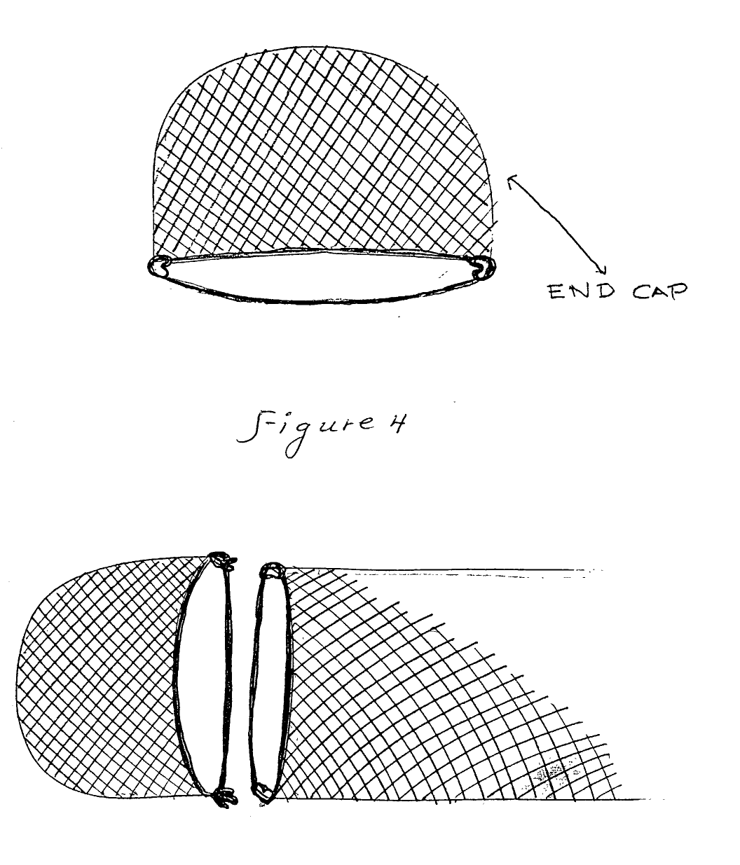

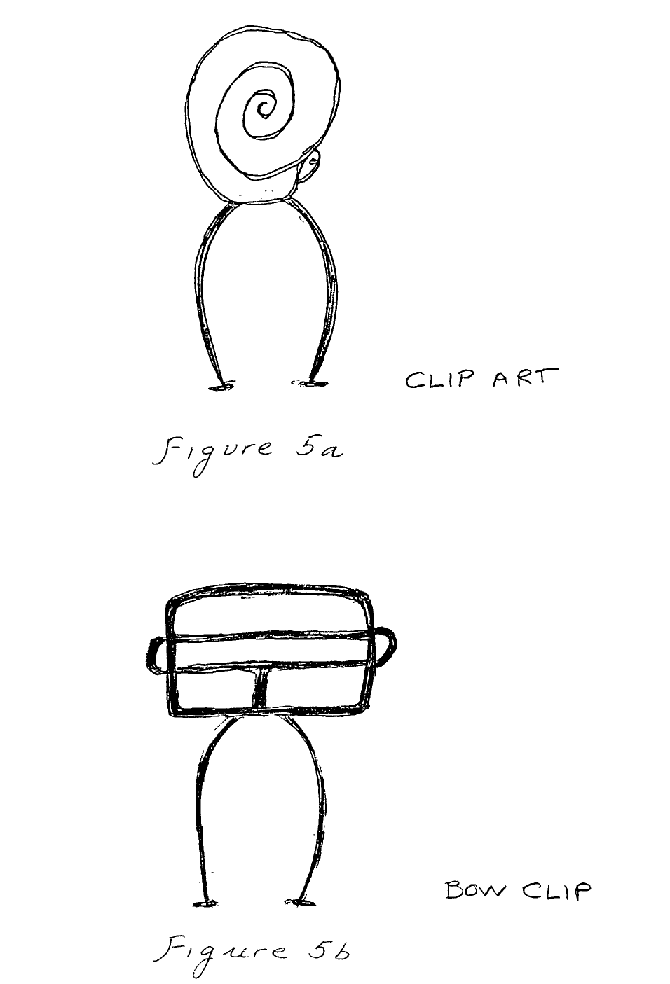

### DESCRIPTION AND EMBODIMENTS OF THE INVENTION

The present invention, referred to herein as a “Floral Wrap” (“FW”) is a flexible, tubular mesh weave or confluent smooth surface body (1) with one or more male (1a) and one or more female (1b) clasps at each terminal end or other medial areas of the body surface that interlock with each other to form any number of particular shapes. A plurality of male and female clasps may be connected to build the FW to any size as large or long as is desired. Other versions of the invention are possible. For example, the male and female clasps may also connect to corresponding male and female clasps on end caps (4), which may be situated on either or both ends of the FW, and which may be almost any shape, including but not limited to a conical or flat shape and may give a finishing point for any variety of garland or swag contours. Because of its elasticity and malleability, the configuration of the FW may take any shape by easily bending and molding the tubular, mesh weave body or confluent smooth surface body to create many different shapes, including as ovals, squares, heart-shapes, S-curve shapes, U-curved, semi-circular, circular and elongated straight shapes.

In an embodiment of the present invention, another additional feature to the FW, which may be utilized is a clip hook (5) attachment, which allows the designer to hang any floral design either vertically or horizontally. The clip hook may be used with the FW at any time in the creative process, even at the end, and it can be repositioned at any time. The capability of the clip hook or plurality of clip hooks to be positioned at any part of the FW gives options of how to hang the floral design. For example, a garland hung on a mirror or an oversized wreath secured outdoors.

In one embodiment of the present invention, the tubular mesh weave is made of metal, rubber, or plastic weave material. The tubular mesh weave may be covered with different coatings or washes that may include, but are not limited to, metal, rubber, or plastic coatings. An example of metal coatings would include silver plate, gold gilding, zinc or other such suitable metal materials. Each of these exterior coatings on the covered wire gives the mesh weave body a different patina, which makes the body itself a decorative part of the floral design. The silver plate, gilded and zinc washed bodies may be used with minimal embellishment or even stand alone as a decorative piece without foliage such as silver framing around table candles. Exterior use over time gives the zinc washed decorator wrap its own unique, aged finish and may be hung with just a holiday ribbon or FW clip art (6).

While the FW can be made from flexible weave material, other embodiments are also contemplated. For example in another embodiment of the present invention, the tubular mesh weave is substituted by a confluent smooth surface body, which can be made of metal, rubber, plastic, or any other suitable material. The confluent smooth surface body may or may not be covered with different coatings or washes that may include, but are not limited to, metal, rubber, or plastic coatings. While no specific weave or coating material will be applicable under all circumstances, one skilled in the art would understand that depending on the conditions under which the FW is to be used, the desired flexibility of the FW, and the contemplated usage of the FW, any type of suitable material, or combination of materials may be used. For example, a metal wire tubular mesh weave may be used in conjunction with a rubberized coating in order to maintain malleability of the FW while utilizing the rubber coating to protect the metal mesh weave from oxidation due to exterior use.

In another embodiment of the present invention, additional features can be utilized with the FW. For example, various attachments may be affixed to any area of the FW that serve as supports for decorative accessories to the FW. The attachments which may be used for decorative supports are bow hooks (7) and clip art attachments (6), which can be inserted into or in other ways affixed to the FW. The attachments may be used to affix any number of decorative items, including, but not limited to display ribbons, insignias made from assorted materials, and original art pieces created as “jewelry” for floral wraps. The clip art may be original art pieces designed by commissioned artists in various mediums, such as stained glass, polymer clay, paper, metal and stone. These art pieces may be seasonal or holiday related or just purely decorative to add color and texture to the floral design. The bow hooks may be placed at any point on the FW, including either the top, bottom or middle and may allow for different ribbon applications to floral or decorative designs.

In another exemplary embodiment of the invention, other attachments are contemplated, including floral foam inserts and plastic sleeves. The floral foam rollers may be inserted inside the FW, which may be watered, and thus allowing for fresh or “living” floral designs. The plastic sleeves are designed to pull over the FW when working with a watered “living” floral design to protect tabletop surfaces. It may also be used over the FW for easy application of non-stemmed items such as fruits and berries when glue attachment is necessary. The plastic sleeve may be removable and keeps the FW free from any messy glue residue.

While this invention is satisfied by embodiments in many different forms, there will herein be described preferred embodiments of the invention, with the understanding that the present disclosure is to be considered exemplary of the principles of the invention and is not intended to limit the invention to the embodiments illustrated and described. Accordingly, this invention is not limited to the particular embodiments disclosed, but is intended to cover all modifications that are within the spirit and scope of the invention as defined by the appended claim.

What is claimed is:

1. A floral wrap comprising:
a) a flexible body; b) one or more interlocking clasps.
